(19) United States
(12) Patent Application Publication
(10) Pub. No.: US 2015/0220896 A1
(43) Pub. Date: Aug. 6, 2015

(54) KIOSK TRANSACTIONS

(71) Applicant: Wal-Mart Stores, Inc., Bentonville, AR (US)

(72) Inventors: David Jon Carr, Mountain View, CA (US); Richard Mark Ramsden, Foster City, CA (US)

(73) Assignee: Wal-Mart Stores, Inc., Bentonville, AR (US)

(21) Appl. No.: 14/169,557

(22) Filed: Jan. 31, 2014

(51) Int. Cl. G06Q 20/18; G06Q 20/12

(52) U.S. Cl. CPC G06Q 20/18; G06Q 20/12

(57) ABSTRACT

The current disclosure extends to facilitation of a transaction for one or more items with a customer via a kiosk. In embodiments, the kiosk is located at or proximate to a retail store. In embodiments, a customer can order products or services via an ordering platform such as a merchant website. The customer may receive an order confirmation and a unique transaction identifier. The customer may then travel to a kiosk at the store and enter the transaction identifier to recall the order. While the order is open at the kiosk, the customer may add or substitute items, order specialty items such as prescriptions or fuel, make payment, and confirm the transaction. Purchased items may then be carried out to the customer at the kiosk.

### BACKGROUND

Currently, one can purchase a wide variety of retail items from numerous Internet websites. Upon completion of a typical Internet transaction, purchased retail items are commonly transported to the customer's selected destination, usually a place of residence or work, from a warehouse or like storage location. In some cases, a retailer may allow customers to order items via a website (or other remote ordering facility, for example a telephone ordering system) and then arrange delivery of the ordered item(s) to a retail location that is local to the customer. The customer may then travel to the local store to pick up the items.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram illustrating components of a kiosk system according to an embodiment of the present disclosure;

FIG. 2 is an illustration of a kiosk computer terminal according to embodiments of the present disclosure;

FIG. 3 is a flow chart illustrating an example method for completing a kiosk transaction in accordance with embodiments of the present disclosure;

FIG. 4 is a flow chart illustrating an example method for making payment for a transaction at a kiosk in accordance with embodiments of the present disclosure;

FIG. 5 is a flow chart illustrating an example method for ordering photo prints during a transaction at a kiosk in accordance with embodiments of the present disclosure;

FIG. 6 is a flow chart illustrating an example method for providing a substitute item during a kiosk transaction in accordance with embodiments of the present disclosure; and

FIG. 7 is a flow chart illustrating an example method for purchasing fuel during a kiosk transaction in accordance with embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The present disclosure extends to methods, systems, and computer programs for providing product delivery, pickup, and/or facilitating additional transactions at a computer terminal kiosk. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowcharts and block diagram in the attached figures illustrate the architecture, functionality, and operation of possible implementations of systems, methods, and computer program products according to various embodiments of the present disclosure. In this regard, each block in the flowcharts or block diagram may represent a module, segment, or portion of code, which comprises one or more executable instructions for implementing the specified logical function(s). It will also be noted that each block of the block diagram and/or flowchart illustrations, and combinations of blocks in the block diagram and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagram block or blocks.

Embodiments of the present disclosure comprise a computer terminal kiosk (which may be referred to herein as a kiosk) at or near a retail store that may facilitate retail transactions and/or delivery of items purchased in retail transactions. In one embodiment, a kiosk allows a customer to enter identifying information in order to recall an open transaction and to arrange for delivery of items purchased in the transaction to the customer at the kiosk. In one embodiment, a kiosk allows a customer to add substitute or additional products and/or services to an order and can carry out payment for any such additional products and/or services.

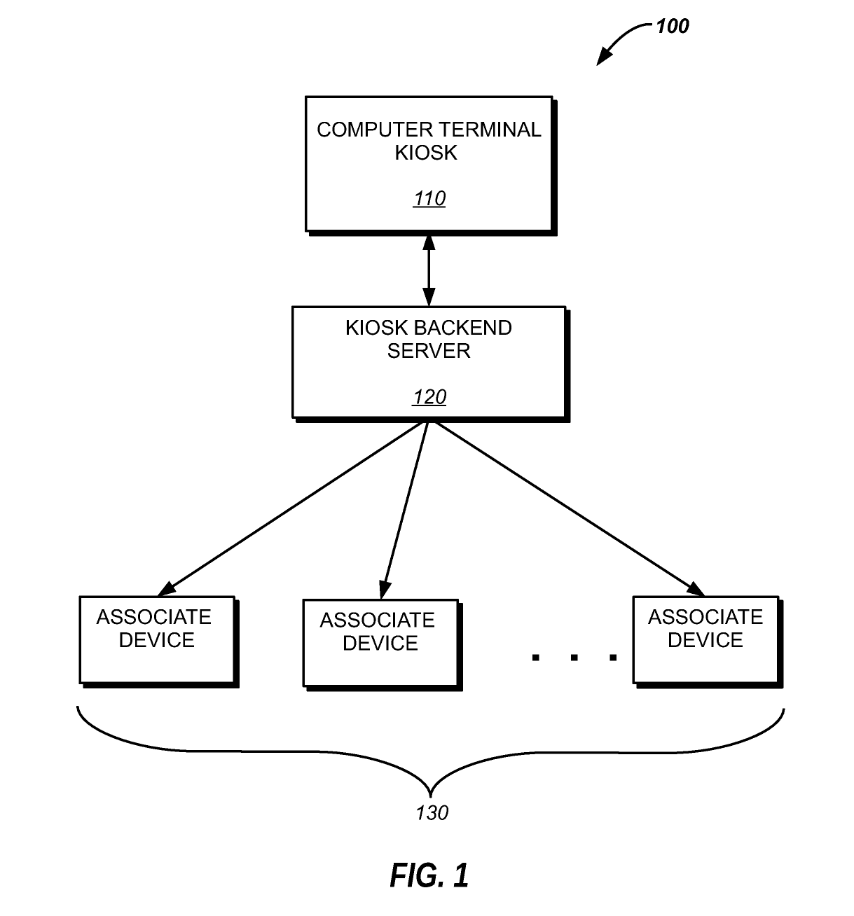

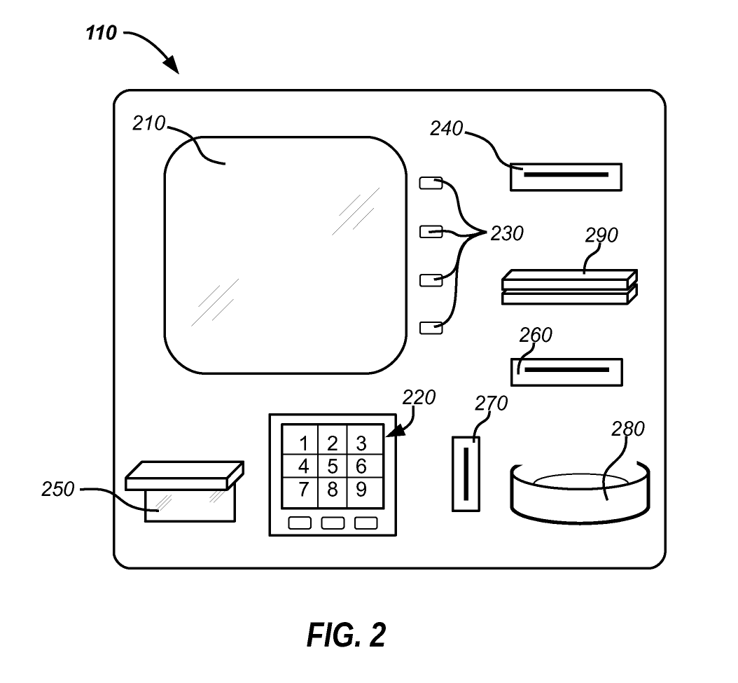

Referring now to FIG. 1, a kiosk system 100 of the present disclosure is illustrated. According to the present disclosure, embodiments of the kiosk system 100 comprise a computer terminal kiosk 110, a kiosk backend server 120, and one or more associate devices 130. An embodiment of kiosk 110 is depicted in FIG. 2. In an embodiment, computer terminal kiosk 110 comprises a network-enabled computing device having a processing unit, a display 210, an input device 220, a memory and computer-readable instructions stored thereon. In an embodiment, the input device of computer terminal kiosk 110 comprises a touch-sensitive display. In alternative embodiments, the input device comprises one or more user-actuated switches, keys 220, buttons 230, or other input devices. In an embodiment, computer terminal kiosk 110 comprises a receipt printer 240. For example, embodiments of the computer terminal kiosk 110 comprise as a thermal printer. In alternative embodiments, the input device comprises a bar code reader 250 or other type of optical input apparatus. In an embodiment, kiosk 110 comprises one or more audio speakers.

In embodiments, kiosk 110 comprises one or more mechanisms to accept payment in paper currency, coins, and/or cashless payment. For example, an embodiment of kiosk 110 according to the present disclosure has a paper currency payment mechanism comprising a cash input feeder 260 and validator, a coin payment mechanism comprising a coin acceptor slot 270, coin return 280, coin validator, and one or more internal coin hoppers, and a cashless payment mechanism comprising a credit/debit card reader 290. Alternative embodiments comprise various combinations of payment acceptance mechanisms, including payment acceptance mechanisms not explicitly set forth herein.

In one embodiment, kiosk 110 comprises a Bluetooth module adapted to communicate with a customer device such as a smartphone. Alternative embodiments comprise modules that can transmit and receive other forms and/or protocols of wireless signals including, but not limited to: wireless USB, near field communication (“NFC”), and communication over Wi-Fi or a cellular network. Transmission of computer-readable signals between kiosk 110 and a customer device may be implemented in embodiments to allow a customer to select products or services for purchase, select pickup or other delivery options, input payment information, or exchange additional information with the customer.

In embodiments, kiosk 110 is installed at or near a retail store. A drive-up kiosk 110 may be placed in a parking area and positioned to be accessible by a customer in an automobile or other vehicle. In embodiments, a walk-up kiosk 110 may be placed along a sidewalk outside a retail store, inside a retail store, or at other locations where products may be delivered to customers. Embodiments of the present disclosure comprise multiple kiosks 110 at a retail location.

In one embodiment, a drive-through kiosk 110 is installed at a drive-through lane. In embodiments, one or more secondary kiosks 110 are installed at parking spaces beyond the exit of the kiosk drive-through lane, such that kiosk traffic may be directed from the drive-through kiosk 110 to a secondary kiosk 110 for transactions that are expected to surpass a threshold waiting time in order to minimize and/or optimize customer wait times at the drive-through kiosk 110. In an embodiment, computer-readable data and/or instructions can be transmitted from the drive-through kiosk 110 to a secondary kiosk 110 regarding a current transaction state to facilitate transfer of a selected transaction from the drive-through kiosk 110 to a secondary kiosk 110. For example, a retail location may include two drive-through kiosks 110 in drive-through lanes. Beyond the exits of the drive-through lanes, a number of parking spaces (for example, 15) are provided. Several of the parking spaces (for example, five) may include drive-up kiosks 110.

In an embodiment, computer terminal kiosk 110 is adapted to transmit and receive computer-readable signals to and from kiosk backend server 120. Computer terminal kiosk 110 is adapted to receive information related to completed and/or pending transactions, including items purchased, items in an electronic shopping cart, item prices, and/or additional or substitute items that may be purchased. Such information may be received at computer terminal kiosk 110 from kiosk backend server 120, or from other sources of transaction data. In embodiments, kiosk 110 is adapted to receive information regarding additional products and/or services that may be purchased by the customer or stock levels of any particular product at the proximate retail store.

In an embodiment, kiosk backend server 120 receives and maintains a record of transactions that have been designated for pickup at a kiosk 110. In another embodiment, kiosk backend server 120 is adapted to query one or more transaction databases and/or order processing modules for data related to transactions that have been designated for pickup at a kiosk 110. Kiosk backend server 120 can receive data related to various types of retail transaction processes. For example, in an embodiment, a web server that carries out retail transactions over the Internet can transmit data related to selected transactions to the kiosk backend server 120. In particular, if a customer selects during a web-based transaction to pick up items at a kiosk 110, then data related to the transaction such as products, price information, customer identification, pickup time, and relevant customer preferences may be transmitted from the web server to the kiosk backend server 120. The kiosk backend server 120 can subsequently transmit the data related to the transaction to the kiosk 110.

In one embodiment, kiosk 110 can transmit instructions to one or more associate devices 130 to direct one or more picker associates to gather purchased items into a delivery group. In one embodiment, the picker associates are employees of the retailer and carry a mobile user device 130 with them to receive instructions, such as those set forth herein. According to embodiments, a picker associate can view a list of items purchased in the transaction, locate the items from store or warehouse shelves, and gather the items in a delivery group.

Device 130 may be embodied in a variety of types of devices. In an example embodiment, device 130 comprises a smartphone or other like mobile device having data and computer-readable instructions stored thereon that direct the device 130 to carry out the functions described in the present disclosure.

In embodiments, communications between computer terminal kiosk 110, kiosk backend server 120, one or more associate devices 130, and/or a customer computing device may be effected over various networks including, but not limited to, a wireless network, a cellular network, an intranet, the Internet, or combinations thereof.

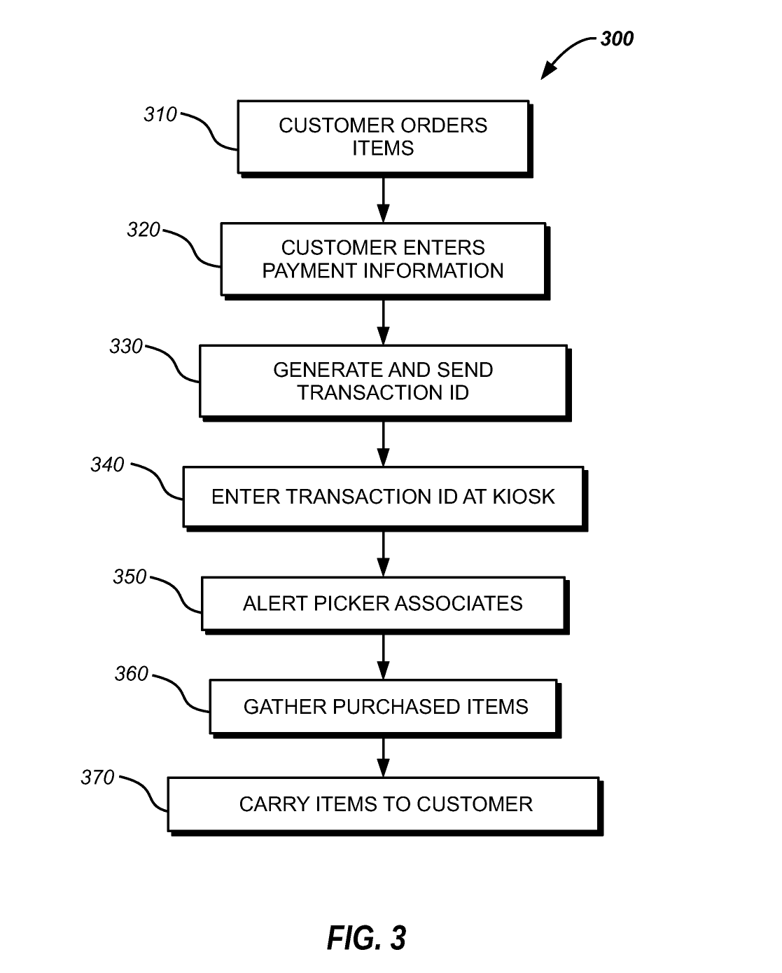

In operation, a kiosk 110 may facilitate curbside delivery of purchased items, supplement and/or complete transactions, and fulfill additional functions relating to retail purchases. Referring now to FIG. 3, embodiments of the present disclosure comprise method 300. At operation 310, a customer places an order for groceries, general merchandise, or other items or services. The order may be placed via a website interface, a mobile computing device interface (for example, an app installed on a customer's smartphone), a kiosk 110, a telephone ordering system, an in-store point of sale terminal, or other system for designating items for purchase. The customer can select groceries, general merchandise, or virtually any other product or service offered. Additional particular selections, such as types of items or quantities, may be input into the ordering interface. In an embodiment, the customer may upload photos to be processed and printed. While placing an order, the customer may select to pick up the purchased products and/or services at a retail location or other location whereat a kiosk 110 is located. Items may be entered into a electronic shopping cart as the customer selects them.

At operation 320, the customer completes the transaction by selecting a payment method and entering payment information, such as a credit or debit card number. Alternative forms of payment may additionally be accepted at various interfaces.

At operation 330, upon confirmation of successful payment, the customer receives a transaction identification code and/or transaction confirmation. In embodiments, the transaction identification code comprises a unique identifier for the particular transaction that was just completed. The transaction identification code can be transmitted to the customer via electronic mail, SMS text message, a web page, a mobile device app interface, or other means. In an embodiment, the customer is presented with a printable bar code, QR code, or other visual code that uniquely identifies the transaction. The customer may be prompted to print the identification for later retrieval of the purchased items.

At operation 340, the customer travels to kiosk 110 and inputs the transaction code/number into kiosk 110 to call up the transaction. Kiosk 110 can retrieve details regarding the transaction from kiosk backend server 120. In embodiments, inputting the transaction code is carried out by placing a printed paper display depicting the bar code, QR code, or the like before a scanner 250 of kiosk 110. In another embodiment, the customer places his or her mobile computing device before the scanner 250 of kiosk 110 while the mobile device display is showing the bar code or QR code, thereby inputting the transaction code. In other embodiments, the customer can enter a transaction number/code using a keypad 220 of kiosk 110. In other embodiments, the customer's mobile device communicates with kiosk 110 over a wireless signal and thereby inputs the transaction number/code to recall the transaction. In alternative embodiments, a customer may log into a customer account with the merchant by entering a username and password into the kiosk 110. Any transactions that were previously associated with the customer account may then be retrieved from kiosk backend server 120. In an embodiment, two or more previous transactions may be combined and carried out at kiosk 110. For example, after the customer has input a transaction identifier code into kiosk 110, he or she may then be prompted to enter an additional transaction code. As another example, after a first transaction has been retrieved at kiosk 110, the customer may enter a username and password and select a previous transaction that was associated with the customer account to be combined with the first transaction.

At operation 350, the kiosk 110 alerts one or more picker associates at the kiosk location via associate devices 130 that an order is placed and a customer is waiting for delivery. Alternatively, a signal is transmitted from kiosk 110 to backend server 120, which in turn transmits a signal to associate devices 130 to alert associates of the order. Accordingly, instructions are transmitted to one or more picker associates to locate and gather the purchased items. At operation 360, the items are then gathered by picker associates from shelves in a retail store, warehouse, or other facility. The items may be collected in a bin, a cart, a box, or other container for transporting the items to the customer at kiosk 110.

At operation 370, the items are carried to the customer at kiosk 110. In embodiments, the items are manually carried by one or more associates. In other embodiments, the items are transported by automated or semi-automated means, such as a conveyor belt or pneumatic tube system.

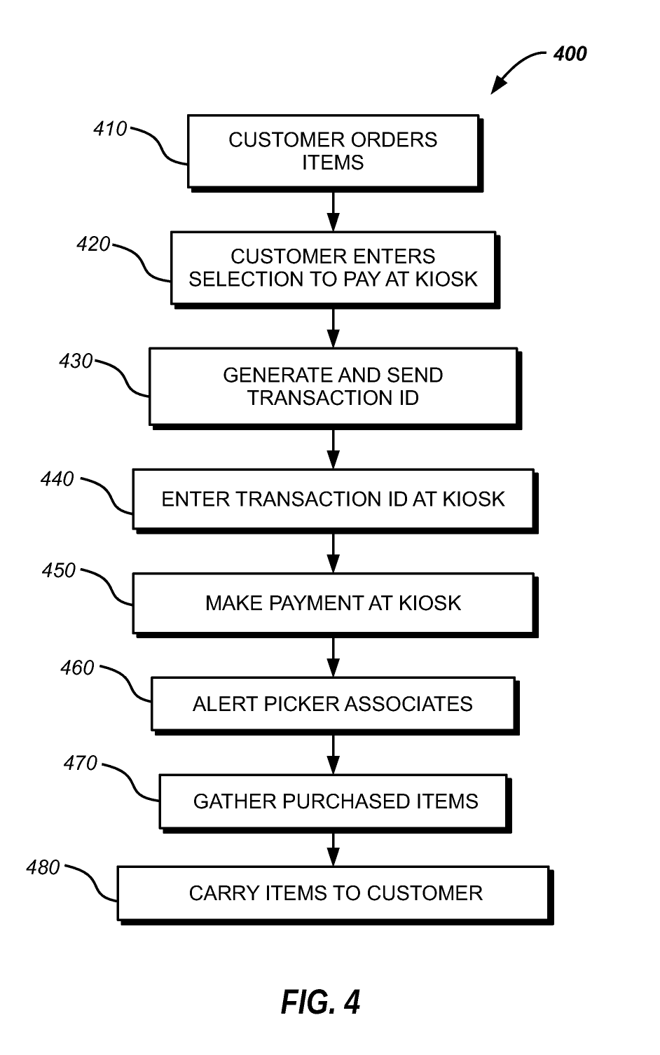

Referring now to FIG. 4, embodiments of the present disclosure comprise method 400. At operation 410, a customer places an order for groceries, general merchandise, or other items or services. At operation 420, the customer inputs a selection to pay at the kiosk 110. At operation 430, the customer receives a transaction identification code and/or transaction confirmation.

At operation 440, the customer inputs the transaction code/number to kiosk 110 to recall the transaction. At operation 450, payment is made at the kiosk 110 by depositing cash and/or coins, or by entering payment card information, for example by swiping a credit or debit card. At operation 460, one or more picker associates at the kiosk 110 location are alerted via associate devices 130 that an order is placed and a customer is waiting for delivery. At operation 470, the items are then gathered by picker associates from shelves in a retail store, warehouse, or other facility. At operation 480, the items are delivered to the customer at the kiosk 110.

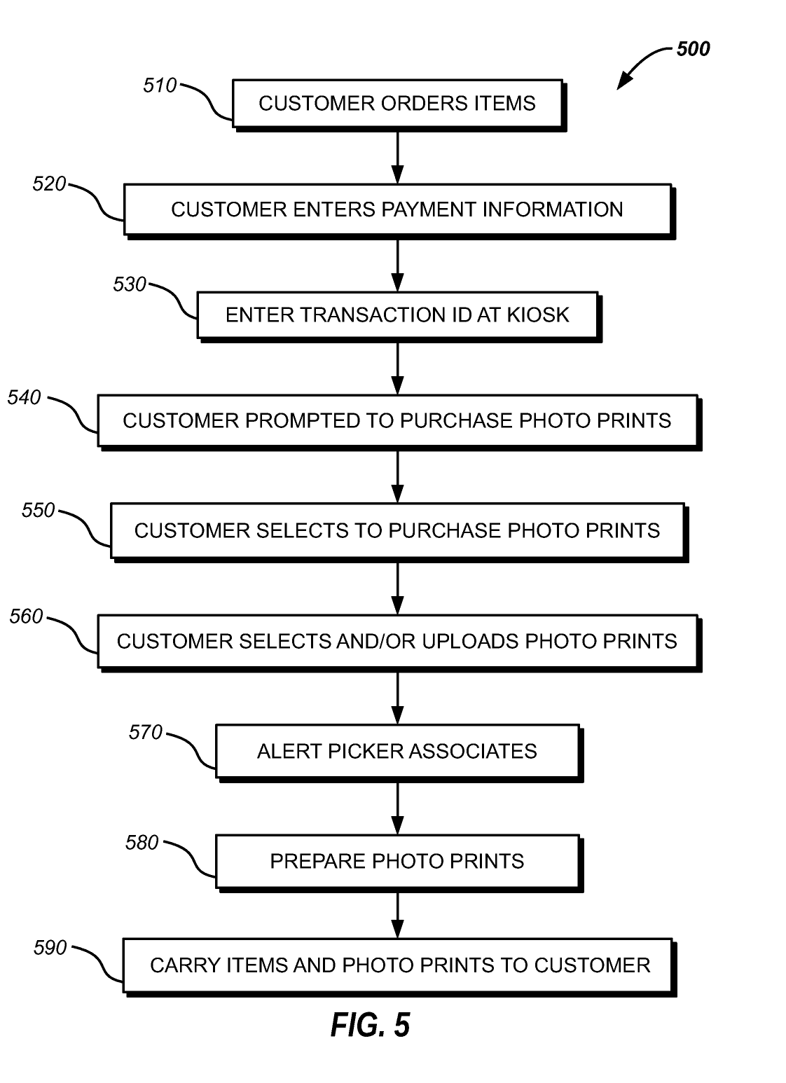

Referring now to FIG. 5, embodiments of the present disclosure comprise method 500. At operation 510, a customer places an order for groceries, general merchandise, or other items or services. At operation 520, the customer completes the transaction by selecting a payment method and entering payment information. The customer may then receive a transaction identification code and/or transaction confirmation.

At operation 530, the customer inputs the transaction code/number at kiosk 110 to recall the transaction. At operation 540, the customer is queried via the kiosk 110 if he or she wants to order photo prints. The query may be made using an audible voice prompt, an on-screen text prompt, or a combination thereof. In embodiments, wireless communication between kiosk 110 and the customer's mobile computing device causes the customer's device to query if the customer wants to order photo prints.

At operation 550, the customer selects that he or she wants to order one or more photo prints. At operation 560, the customer is provided the option to upload photos to print or select previously-uploaded photos to print. In one embodiment, the customer may upload photos via a flash memory “thumb drive” or similar portable memory. In another embodiment, the customer may upload photos from his or her mobile computing device, for example via Bluetooth, Wi-Fi, other wireless communication protocols, or by USB wire or the like. In another embodiment, the customer can sign in to a customer account via kiosk 110 and browse previously-uploaded photos to make a selection of one or more photos to print.

At operation 570, one or more picker associates at the kiosk 110 location are alerted via associate devices 130 that an order is placed and a customer is waiting for delivery. An associate at a photo department is additionally alerted that the customer ordered photo prints. At operation 580, the ordered photo prints are prepared and the photos and other items are gathered by picker associates. At operation 590, the printed photos and purchased items are delivered to the customer at the kiosk 110.

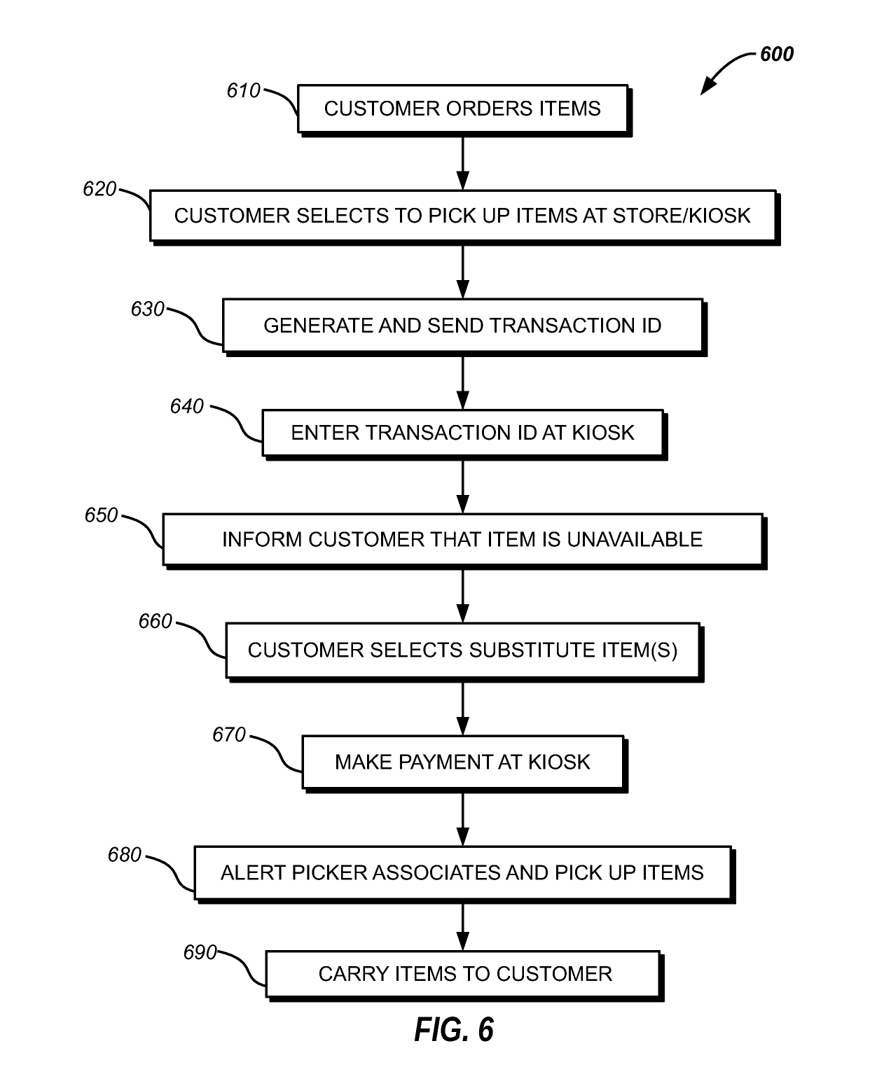

Referring now to FIG. 6, embodiments of the present disclosure comprise method 600, which may be carried out in cases where a selected item is not available, but for which a substitute item is available. At operation 610, a customer places an order for groceries, general merchandise, or other items or services. At operation 620, the customer inputs a selection to pick up purchased items at a store. At operation 630, the customer receives a transaction identification code and/or transaction confirmation.

At operation 640, the customer inputs the transaction code/number to kiosk 110 to recall the transaction. At operation 650, kiosk 110 informs the customer that a selected item is not currently available for purchase at that retail location. In an embodiment, the customer is given several choices regarding the unavailable item, such as: remove the item from the transaction, keep the item in the transaction but ship the item to the customer, keep the item in the transaction and notify the customer once the item becomes available, or substitute the unavailable item with one that is available. Kiosk 110 can provide suggestions regarding acceptable substitute items or let the customer browse all available items. For example, a similar product sold under a different brand, a similar item that is available in different package quantities, or otherwise similar items may be offered as substitute items. At operation 660, the customer makes a selection for a substitute item. The unavailable item is then removed from the transaction and the substitute item is added to the transaction.

In an alternative embodiment, the customer is allowed by kiosk 110 to browse for additional items, even in cases where all items were determined to be available. In such an embodiment, the customer may generally be provided an opportunity to shop and add any selected products or services to the transaction. In another embodiment, the customer can be prompted to purchase additional items if such items are complementary to a product already in the transaction. For example, if a product in the order requires batteries, kiosk 110 asks customer if he or she want to add batteries to the order.

At operation 670, payment is made at the kiosk 110. At operation 680, one or more picker associates at the kiosk 110 location are alerted via associate devices 130 that an order is placed and a customer is waiting for delivery. The items, including any substituted item(s), are then gathered by picker associates from shelves in a retail store, warehouse, or other facility. At operation 690, the items are delivered to the customer at the kiosk 110.

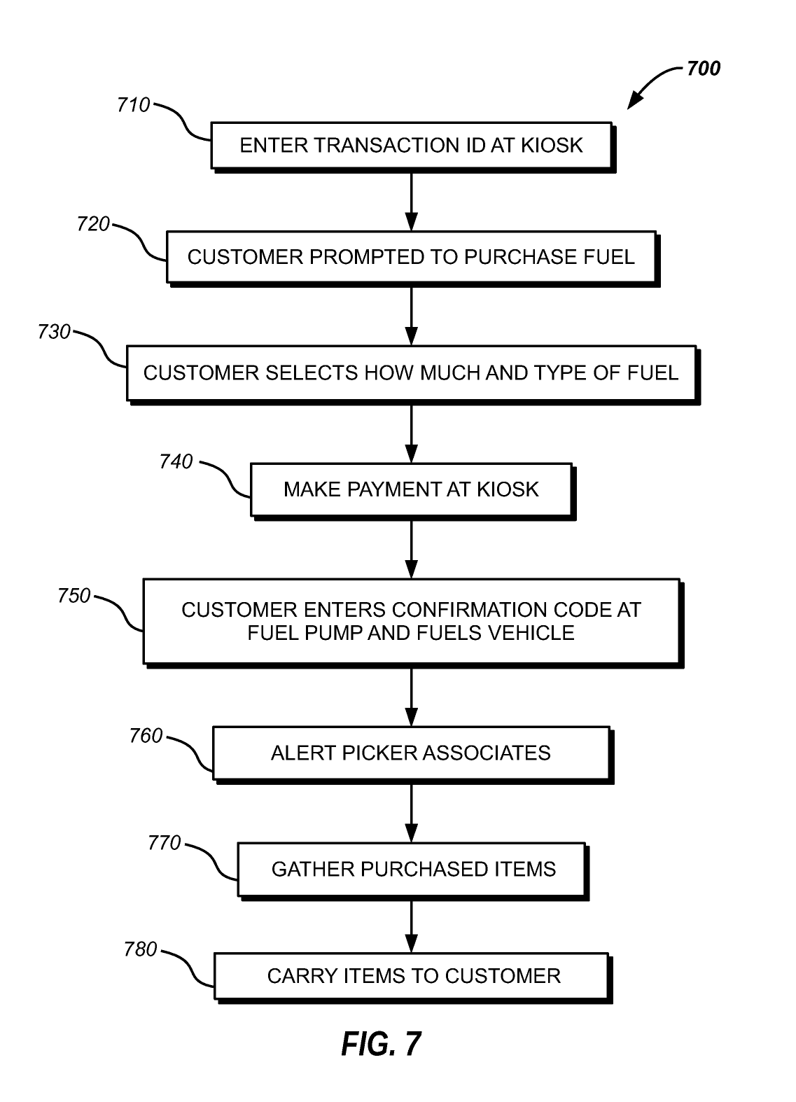

Referring now to FIG. 7, embodiments of the present disclosure comprise method 700, which may be carried out at retail establishments that have fuel pumps at the premises. At operation 710, a customer arrives at kiosk 110, after having initiated a transaction, and inputs a transaction code/number to kiosk 110 to recall the transaction. At operation 720, the customer is prompted to purchase fuel as part of the transaction. At operation 730, the customer can decline or can select how much and what type of fuel to purchase, thereby adding fuel to the transaction. At operation 740, payment is made at the kiosk 110. In an embodiment, a hold is put on the customer's payment card, pending completion of fueling, at which point the entire transaction can be processed via the payment card.

The customer may be provided with a fuel confirmation number or other code. The confirmation number/code may be printed at kiosk 110 or provided electronically via the customer's mobile device. At operation 750, the customer drives to a fuel pump, enters the confirmation number/code at a fuel pump kiosk, and fuels his or her vehicle. The confirmation number/code can be entered at a fuel pump kiosk via a keypad, optical scanner, or other similar means.

At operation 760, one or more picker associates are alerted via associate devices 130 that an order is placed and a customer will be waiting for delivery at the fuel pumps. At operation 770, the items are gathered by picker associates. At operation 780, the items are delivered to the customer at the fuel pump. The associate device 130 can inform the associate which pump the customer is using to assist the associate in identifying the correct recipient of the items.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A method for carrying out a transaction comprising:
at an ordering interface, initiating a transaction with a customer for one or more items;
generating a unique transaction identifier;
transmitting the transaction identifier to the customer;
at a computer terminal kiosk, receiving the transaction identifier; and
transmitting instructions to a picker associate to gather the one or more items and deliver the one or more items to the customer.

2. The method of claim 1, further comprising carrying the one or more items to the customer at the computer terminal kiosk.

3. The method of claim 1, further comprising accepting payment for the transaction at the computer terminal kiosk.

4. The method of claim 1, wherein the computer terminal kiosk is at a retail store drive-through lane.

5. The method of claim 1, wherein the computer terminal kiosk is at a retail store parking lot.

6. The method of claim 1, further comprising effecting a purchase of fuel at the computer terminal kiosk.

7. The method of claim 1, further comprising suggesting a substitute item for the one or more items.

8. The method of claim 1, further comprising effecting a purchase of photo prints at the computer terminal kiosk.

9. The method of claim 1, wherein receiving the transaction identifier further comprises scanning a code at the computer terminal kiosk.

10. The method of claim 1, wherein:
initiating the transaction with a customer comprises authenticating the customer to a customer account and
receiving the transaction identifier comprises authenticating the customer to the customer account at the computer terminal kiosk.

11. A method for carrying out a transaction comprising:
receiving, from a customer, a product order for at least one item via a web-based ordering platform;
assigning a unique identifier to the transaction;
at a computer terminal kiosk, receiving the unique identifier input by the customer;
transmitting data reflecting the product order to the computer terminal kiosk; and
delivering the at least one item to the customer at the computer terminal kiosk.

12. The method of claim 11, further comprising at the computer terminal kiosk, confirming the product order.

13. The method of claim 11, further comprising accepting payment for the product order at the computer terminal kiosk.

14. The method of claim 11, wherein receiving the unique identifier input by the customer comprises scanning, at the computer terminal kiosk, a code.

15. A system for carrying out a transaction comprising:
a computer terminal kiosk adapted to:
receive data regarding at least one item in the transaction;
accept payment for the transaction; and
effect a change to the transaction;
a kiosk backend server adapted to communicate with the computer terminal kiosk; and
at least one associate device adapted to:
receive a communication regarding the at least one item and
provide instructions to a picker associate to gather the at least one item for delivery to a customer at the computer terminal kiosk.

16. The system of claim 15, wherein the computer terminal kiosk is at a retail store drive-through lane.

17. The system of claim 15, wherein the computer terminal kiosk is at a retail store parking lot.
